(19) United States
(12) Patent Application Publication
(10) Pub. No.: US 2013/0101741 A1
(43) Pub. Date: Apr. 25, 2013

(54) WOOD TREATMENT AND TREATED WOOD

(71) Applicant: NISSIN CHEMICAL INDUSTRIES, LTD., Echizen-shi (JP)

(72) Inventors: Masaki Wakamatsu, Echizen-shi (JP); Akira Yamamoto, Echizen-shi (JP)

(73) Assignee: NISSIN CHEMICAL INDUSTRIES, LTD., Echizen-shi (JP)

(21) Appl. No.: 13/708,428

(22) Filed: Dec. 7, 2012

Related U.S. Application Data
(62) Division of application No. 12/977,721, filed on Dec. 23, 2010.

(30) Foreign Application Priority Data
Dec. 28, 2009 (JP) 2009-296743

(51) Int. Cl. B27K 3/16

(52) U.S. Cl. CPC B27K 3/163
USPC 427/297; 427/408

(57) ABSTRACT

Wood is treated with a film-forming silicone emulsion composition, a boron compound, and a di- or trivalent metal salt. The wood can be endowed with water repellency, water absorption prevention, dimensional stability, termite control and antifungal properties without altering the appearance and quality of wood. The treatment is also effective in preventing the boron compound from being leached out in water.

### CROSS-REFERENCE TO RELATED APPLICATIONS

This application is a divisional application of U.S. patent application Ser. No. 12/977,721, filed Dec. 23, 2010, and is based upon and claims the benefits of the priority from Japanese Patent Application No. 2009-296743, which was filed on Dec. 28, 2009, the entire contents of which are incorporated herein by reference.

### TECHNICAL FIELD

This invention relates to a wood treating method using a silicone emulsion capable of forming a rubbery film through crosslinking, a boron compound, and a di- or trivalent metal salt, and a wood thus treated.

### BACKGROUND ART

For wood, boron compounds are used worldwide as antifungal and termite controlling agents by virtue of their safety and long-term stability. Because of their water solubility, however, boron compounds are readily leached out of wood upon outdoor weathering. Their long-term service on outdoor use is not expectable.

Addressing the problem, U.S. Pat. No. 7,658,972 or JP-A 2007-051236 proposes wood treatment including adding a boron compound to a silicone emulsion, and treating wood with the emulsion by surface treatment, immersion treatment, or vacuum or pressure impregnation.

In JP-A H10-323807, wood treatment is carried out by adding magnesium acetate and magnesium hydroxide to a mixture of boric acid, colloidal silica, and chitosan, for fixing boron.

These methods are effective to some extent, but not to a satisfactory extent. There are available no wood treating agents which comply with outdoor use, minimize the leachability of boron compounds, and do not alter the appearance and quality of wood.

### CITATION LIST

Patent Document 1: U.S. Pat. No. 7,658,972 (JP-A 2007-051236)
Patent Document 2: JP-A H10-323807

### SUMMARY OF INVENTION

An object of the present invention is to provide a wood treating method which minimizes the leachability of boron compounds in water without altering the appearance and quality of wood, so that the treated wood may be suited for outdoor use; and a wood thus treated.

The inventors have found that by treating wood with a film-forming silicone emulsion composition, a boron compound, and a di- or trivalent metal salt, the wood can be endowed with water repellency, water absorption prevention, dimensional stability, termite control and antifungal properties without altering the appearance and quality of wood. The treatment is also effective in preventing the boron compound from being leached out in water.

In one aspect, the invention provides a wood comprising in its surface a cured product of a film-forming silicone emulsion composition [I], (F) a boron compound, and (G) a di- or trivalent metal salt.

In a preferred embodiment, 10 to 1,500 parts by weight of the boron compound (F) and 10 to 300 parts by weight of the di- or trivalent metal salt (G) are present per 100 parts by weight of the cured product of film-forming silicone emulsion composition [I], all calculated as solids.

In another preferred embodiment, the silicone emulsion composition [I] is a composition comprising the following components (A) to (E) dispersed and emulsified in water,

(A) 100 parts by weight of an organopolysiloxane containing at least two silicon-bonded hydroxyl groups on the molecule,

(B) 0.5 to 20 parts by weight of the reaction product of an amino-containing organoxysilane and an acid anhydride,

(C) 0 to 20 parts by weight of an epoxy-containing organoxysilane and/or partial hydrolyzate thereof,

(D) 0 to 50 parts by weight of colloidal silica and/or polysilsesquioxane, and

(E) 0 to 10 parts by weight of a curing catalyst.

The di- or trivalent metal salt (G) is typically zinc acetate, zinc chloride, calcium acetate or calcium chloride. The boron compound (F) is typically disodium octaborate tetrahydrate.

In the treated wood, the amount of residual borate in terms of boric acid is at least 5 kg/m³ after the leach-out test of JIS K 1571.

In another aspect, the invention provides a method for treating wood. A silicone emulsion composition [I] is prepared by dispersing and emulsifying in water (A) 100 parts by weight of an organopolysiloxane containing at least two silicon-bonded hydroxyl groups on the molecule, (B) 0.5 to 20 parts by weight of the reaction product of an amino-containing organoxysilane and an acid anhydride, (C) 0 to 20 parts by weight of an epoxy-containing organoxysilane and/or partial hydrolyzate thereof, (D) 0 to 50 parts by weight of colloidal silica and/or polysilsesquioxane, and (E) 0 to 10 parts by weight of a curing catalyst. Also provided are (F) 10 to 1,500 parts by weight of a boron compound and (G) 10 to 300 parts by weight of a di- or trivalent metal salt per 100 parts by weight of active components exclusive of water in the silicone emulsion composition [I], all calculated as solids.

The method in one embodiment comprises the steps of treating a wood with a dispersion containing the silicone emulsion composition [I] and the boron compound (F) by coating, immersion, or vacuum or pressure impregnation, and then treating the wood with the di- or trivalent metal salt (G) by coating or immersion.

The method in another embodiment comprises the steps of treating a wood with the boron compound (F) by coating, immersion, or vacuum or pressure impregnation, and then treating the wood with a dispersion containing the silicone emulsion composition [I] and the di- or trivalent metal salt (G) by coating or immersion.

The method in a further embodiment comprises the steps of treating a wood with the boron compound (F) by coating, immersion, or vacuum or pressure impregnation, treating the wood with the di- or trivalent metal salt (G) by coating or immersion, and then treating the wood with the silicone emulsion composition [I] by coating or immersion.

The di- or trivalent metal salt (G) is typically zinc acetate, zinc chloride, calcium acetate or calcium chloride. The boron compound (F) is typically disodium octaborate tetrahydrate. Also contemplated herein is a wood treated by the method of any one of these embodiments.

### ADVANTAGEOUS EFFECTS OF INVENTION

Wood is treated with a film-forming silicone emulsion composition, a boron compound, and a di- or trivalent metal salt. The wood can be endowed with water repellency, water absorption prevention, dimensional stability, termite control and antifungal properties without altering the appearance and quality of wood. The treatment is also effective in substantially preventing the boron compound from being leached out in water.

According to the present invention, there is a further effect that wood damages due to not only termites including Reticulitermes speratus and Coptotermes formosanus but also Incisitermes minor can be prevented. Termites only live in damp circumstances such as under the floor. On the other hand, Incisitermes minor can live so long as water is present in the wood. Thus, wood damages due to Incisitermes minor gradually increases. Under the above situation, the leachability of boron compounds in water is minimized in the wood treated according to the inventive method. Especially, when the amount of residual borate in the terms of boric acid in the treated wood known as boric acid equivalent (BAE) is at least 5 kg/m³ after the leach-out test of JIS K 1571, the wood damages due to Incisitermes minor can be effectively prevented even if the treated wood is used in Incisitermes minor-live circumstances, e.g., outdoors exposed in rainwater.

### DESCRIPTION OF EMBODIMENTS

As used herein, the notation (Cn-Cm) means a group containing from n to m carbon atoms per group.

According to the invention, wood is treated with a film-forming silicone emulsion composition [I], a boron compound, and a di- or trivalent metal salt. The silicone emulsion composition [I] having a film forming ability is preferably a composition comprising the following components (A) to (E) dispersed and emulsified in water,

(A) 100 parts by weight of an organopolysiloxane containing at least two silicon-bonded hydroxyl groups on the molecule,

(B) 0.5 to 20 parts by weight of the reaction product of an amino-containing organoxysilane and an acid anhydride,

(C) 0 to 20 parts by weight of an epoxy-containing organoxysilane and/or a partial hydrolyzate thereof,

(D) 0 to 50 parts by weight of colloidal silica and/or polysilsesquioxane, and

(E) 0 to 10 parts by weight of a curing catalyst.

Component (A) is an organopolysiloxane having at least two silicon-bonded hydroxyl groups on the molecule. The preferred organopolysiloxane has the following general formula.

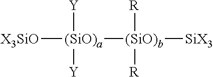

Herein R which may be the same or different is a C₁-C₂₀ alkyl group or C₆-C₂₀ aryl group; X which may be the same or different is a C₁-C₂₀ alkyl group, C₆-C₂₀ aryl group, C₁-C₂₀ alkoxy group or hydroxyl group; and Y which may be the same or different is X or a group —[O—Si(X)₂]_{c}—X. At least two of X and Y groups are hydroxyl groups. The subscript a is a positive number of 0 to 1,000, b is a positive number of 100 to 10,000, and c is a positive number of 1 to 1,000.

More particularly, R is each independently selected from C₁-C₂₀ alkyl groups and C₆-C₂₀ aryl groups, such as methyl, ethyl, propyl, butyl, pentyl, hexyl, heptyl, octyl, nonyl, decyl, dodecyl, tetradecyl, hexadecyl, octadecyl, cyclopentyl, cyclohexyl, cycloheptyl, phenyl, tolyl, and naphthyl, with methyl being preferred. X is each independently selected from C₁-C₂₀ alkyl groups, C₆-C₂₀ aryl groups, C₁-C₂₀ alkoxy groups and hydroxyl groups, such as methyl, ethyl, propyl, butyl, pentyl, hexyl, heptyl, octyl, nonyl, decyl, dodecyl, tetradecyl, hexadecyl, octadecyl, cyclopentyl, cyclohexyl, cycloheptyl, phenyl, tolyl, naphthyl, methoxy, ethoxy, propoxy, butoxy, hexyloxy, heptyloxy, octyloxy, decyloxy, and tetradecyloxy as well as hydroxyl. Y is each independently selected from X and groups —[O—Si(X)₂]_{c}—X wherein c is a positive number of 1 to 1,000. If “a” is more than 1,000, the resulting coating has insufficient strength. Thus “a” is a number of 0 to 1,000, preferably 0 to 200. If b is less than 100, the resulting coating becomes less flexible. If b is more than 10,000, the resulting coating has reduced tear strength. Thus b is a positive number of 100 to 10,000, preferably 1,000 to 5,000. For crosslinking, at least two hydroxyl groups must be included on the molecule, preferably 2 to 4 hydroxyl groups being included.

Illustrative examples of the organopolysiloxane are given below.

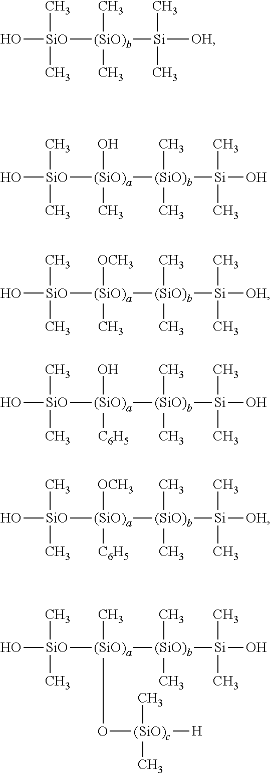

Herein, a, b and c are as defined above.

Such organopolysiloxane can be synthesized by well-known methods. For example, it is obtained through equilibration reaction between a cyclic siloxane such as octamethylcyclotetrasiloxane and an, -dihydroxysiloxane oligomer in the presence of a catalyst such as a metal hydroxide. Since component (A) is preferably used in emulsion form, it may be prepared as an emulsion by a well-known emulsion polymerization method. Thus it may be readily synthesized by previously emulsifying and dispersing a cyclic siloxane or an, -dihydroxysiloxane oligomer, an, -dialkoxysiloxane oligomer, alkoxysilane or the like in water using an anionic or cationic surfactant, optionally adding a catalyst such as an acid or basic material, and effecting polymerization reaction.

The anionic or cationic surfactant used herein is not particularly limited. Examples include alkylsulfate salts, alkylbenzenesulfonate salts, alkylphosphate salts, polyoxyethylene alkylsulfate salts, alkylamine hydrogen chloride salts, and alkylamine acetate salts. The surfactant is usually used in an amount of about 0.1 to 20% by weight based on the siloxane(s).

Examples of the catalysts such as acid and basic materials include sulfuric acid, hydrochloric acid, phosphoric acid, acetic acid, formic acid, lactic acid, trifluoroacetic acid, potassium hydroxide, sodium hydroxide, and ammonia. They may be used in catalytic amounts. Where acidic materials like alkylbenzenesulfonates, alkylsulfates and alkylphosphates are used as the surfactant, the catalyst is unnecessary.

Component (B) is the reaction product of an amino-containing organoxysilane and an acid anhydride, which serves to improve the adhesion of a silicone coating to the substrate or wood. The product is obtained preferably by reacting an amino-containing alkoxysilane with a dicarboxylic acid anhydride.

The amino-containing alkoxysilane as one reactant has the general formula.

A(R)_{g}Si(OR)_{3-g}

Herein R is as defined above, A is an amino-containing group of the formula —R¹(NHR¹)ₕNHR² wherein R¹ is each independently a divalent hydrocarbon group of 1 to 6 carbon atoms, typically an alkylene group such as methylene, ethylene, propylene, butylene or hexylene, R² is R or hydrogen, h is an integer of 0 to 6, and g is 0, 1 or 2. Illustrative examples of the amino-containing alkoxysilane are given below.

(C₂H₅O)₃SiC₃H₆NH₂

(C₂H₅O)₂(CH₃)SiC₃H₆NH₂

(CH₃O)₃SiC₃H₆NH₂

(CH₃O)₂(CH₃)SiC₃H₆NH₂

(CH₃O)₃SiC₃H₆NHC₂H₄NH₂

(CH₃O)₂(CH₃)SiC₃H₆NHC₂H₄NH₂

Examples of the dicarboxylic anhydride for reaction with the amino-containing organoxysilane include maleic anhydride, phthalic anhydride, succinic anhydride, methylsuccinic anhydride, glutaric anhydride, and itaconic anhydride, with maleic anhydride being preferred.

The reaction is performed simply by mixing the amino-containing organoxysilane with the acid anhydride in such amounts that a molar ratio of amino groups to acid anhydride is 0.5-2:1, especially 0.8-1.5:1, optionally in a hydrophilic organic solvent, at room temperature or elevated temperature. Suitable hydrophilic organic solvents, if used, include alcohols such as methanol, ethanol, isopropanol and butanol, ketones such as acetone and methyl ethyl ketone, acetonitrile, and tetrahydrofuran. The amount of hydrophilic organic solvent used is 0 to about 100% by weight of the reaction product.

An appropriate amount of component (B) is 0.5 to 20 parts by weight per 100 parts by weight of component (A). Less than 0.5 part of component (B) fails to improve the adhesion to wood whereas more than 20 parts of component (B) makes the coating hard and brittle. The preferred amount of component (B) is 1 to 10 parts by weight.

It is noted that when the reaction of amino-containing organoalkoxysilane with acid anhydride is carried out in a hydrophilic organic solvent, the reaction solution may be used as component (B) directly or after the solvent is stripped off.

Component (C) is an epoxy-containing organoxysilane and/or a partial hydrolyzate thereof, which serves to improve the adhesion of a silicone coating to the substrate or wood. Examples include -glycidoxypropyltrimethoxysilane, -glycidoxypropyldimethoxymethylsilane, -(3,4-epoxycyclohexyl)ethyltrimethoxysilane, and -(3,4-epoxycyclohexyl)ethyldimethoxymethylsilane. Partial hydrolyzates of these silanes are also included.

An appropriate amount of component (C) is 0 to 20 parts by weight per 100 parts by weight of component (A). More than 20 parts of component (C) makes the coating hard and brittle. The preferred amount of component (C) is 0 to 10 parts by weight. When used, the amount of component (C) is preferably at least 1 part by weight.

Component (D) is colloidal silica and/or polysilsesquioxane, which serves as a coating reinforcement. Examples include colloidal silica and polymethylsilsesquioxane which is a hydrolytic condensate of trimethoxymethylsilane.

Some colloidal silicas which can be used herein are commercially available. While the type is not critical, those colloidal silicas stabilized with sodium, ammonium or aluminum are preferable. Suitable commercial examples include Snowtex by Nissan Chemical Industries, Ltd., Ludox by Dupont, Silicadol by Nippon Chemical Industrial Co., Ltd., Adelite AT by Asahi Denka Co., Ltd., and Cataloid S by Catalysts & Chemicals Industries Co., Ltd.

Polymethylsilsesquioxane is obtained by adding an acid such as sulfuric acid or a basic compound such as potassium hydroxide as a condensation catalyst to an aqueous solution of a surfactant, adding dropwise trimethoxymethylsilane thereto, and stirring the mixture, thereby yielding an emulsion of polymethylsilsesquioxane. In this reaction, it is acceptable to add an alkoxytrialkylsilane, dialkoxydialkylsilane, tetraalkoxysilane or the like for adjusting the degree of crosslinking of polysilsesquioxane. It is also acceptable to add a vinylsilane, epoxysilane, acrylic silane, methacrylic silane or the like for enhancing the reactivity of polysilsesquioxane.

Also preferably component (D) has an average particle size of 2 to 200 nm, more preferably 5 to 100 nm. It is noted that the average particle size is measured by the BET method.

An appropriate amount of component (D) is 0 to 50 parts by weight per 100 parts by weight of component (A). More than 50 parts of component (D) makes the silicone coating hard and brittle. The preferred amount of component (D) is 0 to 30 parts by weight. When used, the amount of component (D) is preferably from 10 to 50 parts by weight and more preferably from 10 to 30 parts by weight.

Component (E) is a curing catalyst for inducing condensation reaction of the components of the composition for achieving quick crosslinking and curing. Suitable catalysts include metal salts of organic acids such as dibutyltin dilaurate, dibutyltin dioctate, dioctyltin dilaurate, dioctyltin diversatate, dioctyltin diacetate, dibutyltin bisoleylmaleate, tin octylate, zinc stearate, zinc octylate, and iron octylate; and amine compounds such as n-hexylamine and guanidine. These curing catalysts except water-soluble ones are desirably emulsified and dispersed in water with the aid of surfactants to form emulsions, prior to use.

An appropriate amount of component (E) is 0 to 10 parts by weight per 100 parts by weight of component (A). If more than 10 parts of the catalyst is used, a portion thereof can be left in the coating as non-volatile matter and adversely affect the coating properties. The preferred amount of component (E) is 0 to 5 parts by weight. When used, the amount of component (E) is preferably at least 0.5 part by weight.

In the silicone emulsion composition [I], silane coupling agents, silicone resins, silicone oils, or powdered silicone resins may be added and compounded, if desired, for further improving the properties of a coating thereof, as long as the objects of the invention are not compromised. Suitable silane coupling agents include various silanes having acryloxy, methacryloxy, mercapto, carboxyl and cyano groups. Suitable silicone resins are trialkylsiloxypolysilicates. Suitable silicone oils include, -dihydroxyalkylpolysiloxanes and alkylpolysiloxanes. Suitable powdered silicone resins include silicone resin powder and silicone rubber powder.

In the silicone emulsion composition [I], various additives may be compounded if desired, such as, for example, thickeners, pigments, dyes, penetrants, antistatic agents, antifoaming agents, flame retardants, antifungal agents, and water repellents.

Although the method of preparing silicone emulsion composition [I] by dispersion and emulsification is not particularly limited, the composition is typically prepared by adding components (B), (C), (D) and (E) to component (A) with stirring, and continuing stirring for 30 minutes to 1 hour. The resulting silicone emulsion composition [I] preferably contains active components or solids in a concentration of 35 to 60% by weight, more preferably 40 to 55% by weight.

According to the invention, (F) a boron compound is also used. Suitable boron compounds include boric acid, borax, disodium octaborate tetrahydrate (Na₂B₈O₁₃.4H₂O), and trialkyl borates such as trimethyl borate, triethyl borate, tripropyl borate and tributyl borate. Of these, borax and alkali metal salts of boric acid such as disodium octaborate tetrahydrate are preferred, with disodium octaborate tetrahydrate being most preferred.

The amount of boron compound (F) used in treatment is preferably 10 to 1,500 parts by weight, more preferably 40 to 1,300 parts by weight per 100 parts by weight of active components (exclusive of water) in the silicone emulsion composition [I]. An amount of component (F) in the preferred range exhibits excellent properties including water absorption, weather resistance, rot-proof, termite-controlling, and drying.

It is noted that boron compound (F) penetrates deeply into wood whereas silicone emulsion composition [I] forms a film near the surface of wood. Then an appropriate ratio of boron compound (F) to silicone emulsion composition [I] varies depending on the size of wood. For example, in the case of a wood member with dimensions of 2 cm 2 cm 1 cm as prescribed in the test of JIS K1571, about 10 to 300 parts by weight of boron compound (F) is used per 100 parts by weight of silicone emulsion composition [I]. In the case of a wood member with dimensions of 10 cm 10 cm 100 cm, about 1,200 to 1,300 parts by weight of boron compound (F) is used per 100 parts by weight of silicone emulsion composition [I]. As the size of wood member becomes larger, equivalent effects are achieved with a smaller amount of silicone emulsion composition [I] relative to the amount of boron compound (F).

According to the invention, (G) a di- or trivalent metal salt is also used. The metal salt is not particularly limited as long as it is water soluble. Exemplary di- or trivalent metal salts include zinc acetate, zinc chloride, calcium acetate, calcium chloride, and aluminum chloride. Inter alia, alkaline earth metal salts and zinc salts are preferred, with zinc acetate being most preferred. The di- or trivalent metal salts may be used alone or in admixture.

The amount of metal salt (G) used in treatment is 5 to 300 parts by weight, preferably 10 to 100 parts by weight per 100 parts by weight of active components (exclusive of water) in the silicone emulsion composition [I]. An amount of component (G) in the preferred range exhibits excellent properties including water absorption, weather resistance, rot-proof, termite-controlling, and drying.

The wood which can be treated herein is not particularly limited and encompasses a variety of woods including solid wood, plywood, veneer laminated wood, laminated veneer lumbers (LVL), and particle boards.

The wood treating method of the invention includes several preferred variants. One preferred method includes treating wood with a freshly prepared mixture of component (F) and silicone emulsion composition [I] by coating, immersion or vacuum or pressure impregnation, then treating the wood with component (G) by coating or immersion. Another preferred method includes treating wood with component (F) by coating, immersion or vacuum or pressure impregnation, then treating the wood with a freshly prepared mixture of silicone emulsion composition [I] and component (G) by coating or immersion. A further preferred method includes treating wood with component (F) by coating, immersion or vacuum or pressure impregnation, then treating the wood with component (G) by coating or immersion, and further treating the wood with silicone emulsion composition [I] by coating or immersion.

In the case of immersion, it is preferred to immerse wood in a treating liquid(s) for a total time of 5 minutes to 3 hours. The treating amount (amount of active components deposited on and taken in wood) is preferably 5 to 60 kg/m³, more preferably 10 to 30 kg/m³ on a dry weight basis. The treating amount may be adjusted in accordance with whether the treating mode is vacuum or atmospheric, the concentration of treating liquid, or the like. In the case of coating, the treating amount is preferably 5 to 60 kg/m³, more preferably 10 to 30 kg/m³ on a dry weight basis.

The method of applying silicone emulsion composition [I], boron compound (F), and metal salt (G) to wood by coating, immersion, or vacuum or pressure impregnation is not particularly limited. Well-known techniques that can be used herein include surface treatment such as brush coating, roll coating, and spray coating, immersion treatment, and vacuum or pressure impregnation. Once the treating liquid is applied, it is dried at normal temperature, forming a cured coating. The processing time can be reduced by heating at room temperature to about 150° C. for promoting the cure. The cured coating has rubbery quality.

After wood is treated by the method, the amount of residual borate in terms of boric acid in wood, known as boric acid equivalent (BAE), is preferably at least 5 kg/m³, more preferably 5 to 20 kg/m³ after the leach-out test of JIS K1571, to be described later. With a BAE of at least 5 kg/m³, the weight loss after the termite-controlling in-vitro test of JIS K1571 may be reduced to the ideal value of 3% or below. Treatment with component (F), boron compound alone or in combination with silicone emulsion composition [I] could provide a certain BAE value, but not a BAE value of at least 5 kg/m³ after the leach-out test. By further combining them with metal salt (G), it becomes possible to attain a BAE value of at least 5 kg/m³. The boron compound (F) reacts with the di- or trivalent metal salt (G) to form a substantially water-insoluble boric acid compound on the wood surface. This mechanism prevents the boron compound from being leached out.

A cured coating of the silicone emulsion composition plus components (F) and (G) is effective for preventing water absorption and has a good ability to conform to the substrate due to rubbery quality, suggesting that it is unsusceptible to cracking. The coating is thus effective in preventing the boron compound from being leached out in water, typically rain water. The coating is fully permeable to air while maintaining high water repellency and water absorption prevention. The coating has no adverse impact on the air-permeable and other inherent properties of wood.

### Example

Preparation Examples, Examples and Comparative Examples are given below for further illustrating the present invention. These examples should not be construed as limiting the invention. Unless otherwise stated, parts and percents are by weight.

### Preparation Example 1

A 2-L polyethylene beaker was charged with 498 g of octamethylcyclotetrasiloxane, 2 g of triethoxyphenylsilane, 50 g of 10% sodium laurylsulfate aqueous solution and 50 g of 10% dodecylbenzenesulfonate aqueous solution, which were homogeneously emulsified using a homomixer. Water, 400 g, was slowly added for dilution, and the diluted liquid passed twice through a high-pressure homogenizer under a pressure of 300 kgf/cm², yielding a homogeneous white emulsion. This emulsion was transferred to a 2-L glass flask equipped with a stirrer, thermometer and reflux condenser, where it was subjected to polymerization reaction at 50° C. for 24 hours and aged at 10° C. for 24 hours. This was followed by neutralization to pH 6.2 with 12 g of 10% sodium carbonate aqueous solution. The emulsion thus obtained had a nonvolatile content of 45.4% upon drying at 105° C. for 3 hours, and contained a non-flowing, soft gel-like organopolysiloxane having an average composition represented by [(CH₃)₂SiO_{2/2}]/[(C₆H₅)SiO_{3/2}]=100/0.1 (molar ratio) and end-capped with hydroxyl groups. In this way, an emulsion [A-1] containing 44.4% of component (A) was obtained.

### Preparation Example 2

A 2-L polyethylene beaker was charged with 500 g of octamethylcyclotetrasiloxane, 50 g of 10% sodium laurylsulfate aqueous solution and 50 g of 10% dodecylbenzenesulfonate aqueous solution, which were homogeneously emulsified using a homomixer. Water, 400 g, was slowly added for dilution, and the diluted liquid passed twice through a high-pressure homogenizer under a pressure of 300 kgf/cm², yielding a homogeneous white emulsion. This emulsion was transferred to a 2-L glass flask equipped with a stirrer, thermometer and reflux condenser, where it was subjected to polymerization reaction at 50° C. for 24 hours, and aging at 10° C. for 24 hours. This was followed by neutralization to pH 6.2 with 12 g of 10% sodium carbonate aqueous solution. The emulsion thus obtained had a nonvolatile content of 45.5% upon drying at 105° C. for 3 hours, and contained a gum-like organopolysiloxane of the formula HO—[(CH₃)₂SiO]ₙ—H having a viscosity of at least 1,000 Pa·s. In this way, an emulsion [A-2] containing 44.5% of component (A) was obtained.

### Preparation Example 3

Maleic anhydride, 154 g, was dissolved in 500 g of ethanol, after which 346 g of 3-aminopropyltriethoxysilane was added dropwise at room temperature over one hour. Reaction was performed under ethanol reflux at 80° C. for 24 hours, yielding a pale yellow clear solution [B-1] containing 50% of component (B). This solution had a nonvolatile content of 45.1% upon drying at 105° C. for 3 hours. The reaction product in the solution consisted of about 60% of a mixture of (C₂H₅O)₃SiC₃H₆—NHCO—CH═CHCOOH and (C₂H₅O)₃SiC₃H₆—NH₃⁺⁻OCOCH═CHCOOC₂H₅ and the remainder (about 40%) of oligomers derived therefrom, as analyzed by IR, GC, NMR and GCMS.

### Preparation Example 4

A 2-L polyethylene beaker was charged with 300 g of dioctyltin dilaurate and 50 g of polyoxyethylene nonyl phenyl ether (EO 10 mole addition product), which were homogeneously mixed using a homomixer. Water, 650 g, was slowly added for achieving emulsification and dispersion in water, and the dispersion passed twice through a high-pressure homogenizer under a pressure of 300 kgf/cm², yielding an emulsion [E-1] containing 30% of component (E).

### Comparative Preparation Example 1

A reactor equipped with a thermometer, stirrer, reflux condenser and dropping funnel was charged with 2.0 g of a reactive emulsifier (Adeka Reasoap SE-10N, Asahi Denka Co., Ltd.) and 342.1 g of water and heated to a temperature of 75° C. An emulsion was prepared by adding 2.0 g of a reactive emulsifier (Adeka Reasoap SE-10N) to 244.5 g of water, dissolving the emulsifier, further adding a mixture of unsaturated monomers: 230 g of 2-ethylhexyl acrylate, 230 g of styrene, 19 g of glycidyl methacrylate, and 12.5 g of methacrylic acid, and stirring the contents for emulsification. This emulsion was fed to the dropping funnel. A 5% portion of this monomer mixture emulsion was transferred to the reactor, and 0.5 g of potassium persulfate added as a polymerization initiator, after which the reactor was heated to 80° C. and held for 10 minutes. Thereafter, the remainder of the monomer mixture emulsion and 50.0 g of 3% potassium persulfate were evenly added dropwise to the reactor over 3 hours. After the completion of addition, the mixture was held at 80° C. for one hour for maturing reaction. It was cooled to room temperature and neutralized with 3.5 g of ammonia water. There was obtained Emulsion [A-3] having a solid concentration of 45%.

Silicone emulsion compositions were prepared by combining components (A) and (B) prepared above with -glycidoxypropyltrimethoxysilane [C-1] as component (C) and colloidal silica (Snowtex C, by Nissan Chemical Industry Co., Ltd., active component 20%, average particle size 10-20 nm) as component (D). The mixing formulation is shown in Table 1.

TABLE 1
Mixing formulation (net weight: pbw)

| Silicone emulsion | | | | | | | |
|---|---|---|---|---|---|---|---|
| composition | | EM-1 | EM-2 | EM-3 | EM-4 | EM-5 | EM-6 |
| Component A | [A-1] | 100 | | 100 | | 100 | |
| | [A-2] | | 100 | | 100 | | |
| | [A-3] | | | | | | 100 |
| Component B | [B-1] | 5 | 7 | 20 | 0.5 | 0.5 | |
| Component C | [C-1] | 5 | 7 | | 20 | 2 | |
| Component D | [D-1] | 15 | | | | 20 | |
| Component E | [E-1] | 1 | 5 | 1 | 1 | | |

### Test Sample Preparation

It is noted that the borate used in the following Examples was Na₂B₈O₁₃.4H₂O and commercially available under the trade name of Timbor® from U.S. Borax Inc., and that the wood pieces used included three cedar sap wood pieces of 1.4 cm 3 cm 3 cm (butt end 1.4 3 cm) and nine cedar sap wood pieces of 2 cm 2 cm 1 cm (butt end 2 2 cm).

### Examples 1 to 5

### Silicone Emulsion+Borate Zinc Acetate

A borate Timbor® was dissolved in deionized water to form a 6% aqueous solution. The silicone emulsion composition shown in Table 1 was diluted with deionized water to a concentration of 11.2% of active components. A treating liquid was prepared by mixing 100 parts of the 6% borate aqueous solution with 100 parts of the silicone emulsion composition (11.2% active components). Three cedar sap wood pieces of 1.4 cm 3 cm 3 cm (butt end 1.4 3 cm) and nine cedar sap wood pieces of 2 cm 2 cm 1 cm (butt end 2 2 cm) were immersed in the liquid under a reduced pressure of −93 kPa for 2 hours, aged in an atmosphere of 25° C. and 36% RH for 3 days, and dried at 105° C. for 1 hour. Thereafter, the wood pieces were immersed in a 10% zinc acetate aqueous solution under atmospheric pressure for 20 seconds, aged in an atmosphere of 25° C. and 36% RH for 1 day, and dried at 105° C. for 24 hours. In this way, modified wood pieces were obtained. The three cedar sap wood pieces of 1.4 cm 3 cm 3 cm were subject to a water absorption test, whereas the nine cedar sap wood pieces of 2 cm 2 cm 1 cm were subject to a residual borate test. It is now described how to determine a water absorption and a residual boric acid equivalent (BAE) of modified wood samples. The wood treating dosage and the test results are shown in Table 2. The wood treating dosage is determined by measuring a dry weight at the end of every step and reported in solid weight ratio in Table 2.

Water Absorption Test

The samples were entirely immersed in water for 24 hours, after which they were taken out and weighed. A percent water absorption was calculated according to the equation:

% water absorption=[(W−W0)/W0]100

wherein W0 is the weight (g) of the sample before water immersion and W is the weight (g) of the sample immediately after water immersion. An average of three samples was reported.

Measurement of BAE

As described below, according to JIS K 1571, the following leach-out test was carried out on the samples, and an amount of residual borate in terms of boric acid, i.e., boric acid equivalent (BAE) was determined after the test.

A set of nine wood pieces was placed in a 500-ml beaker, to which deionized water in a volume which was 10 times the volume of the samples was poured so that the samples were submerged under the water surface. By installing a magnetic stirrer and rotating the stir bar at 400-450 rpm, the water was stirred at a temperature of 25° C. for 8 hours for leaching out the chemical. Immediately thereafter, the samples were taken out and lightly drained of water from the surface. Subsequently, the samples were held in an air circulating dryer at a temperature of 60° C. for 16 hours, allowing the volatiles to volatilize off. The foregoing procedure was repeated ten times.

The wood sample was placed in a Teflon® beaker, which received 50 ml of 3% aqueous nitric acid and was heated on a hot plate at 200° C. for 2 hours. The beaker was cooled down, after which water was added to a constant volume of 50 ml. This procedure was repeated five times. At the end of every procedure, the amount of boron was measured by an ICP analyzer. The total of these amounts is the amount of residual borate (or BAE) in the wood sample. The result is an average of nine samples.

### Examples 6 and 7

### Silicone Emulsion+Borate Zinc Acetate

Test samples were prepared and tested as in Examples 1 to 5 except that the wood treating dosage was changed. The concentration of Timbor® aqueous solution was changed to 1.5% in Example 6 and 15% in Example 7. The treating liquid in Example 6 consisted of 100 parts of silicone emulsion composition EM-1 and 100 parts of the 1.5% Timbor® aqueous solution, and the treating liquid in Example 7 consisted of 100 parts of silicone emulsion composition EM-1 and 200 parts of the 15% Timbor® aqueous solution. The wood treating dosage and the test results are shown in Table 2.

### Examples 8 and 9

### Silicone Emulsion+Borate Zinc Acetate

Test samples were prepared and tested as in Examples 1 to 5 except that the wood treating dosage was changed. The concentration of zinc acetate aqueous solution was changed to 0.5% in Example 8 and 15% in Example 9. The silicone emulsion composition used was EM-1. The wood treating dosage and the test results are shown in Table 2.

### Example 10

### Silicone Emulsion+Borate Zinc Chloride

A borate Timbor® was dissolved in deionized water to form a 6% aqueous solution. The silicone emulsion composition EM-1 shown in Table 1 was diluted with deionized water to a concentration of 11.2% of active components. A treating liquid was prepared by mixing 100 parts of the 6% borate aqueous solution with 100 parts of the silicone emulsion composition (11.2% active components). Wood pieces were immersed in the liquid under a reduced pressure of −93 kPa for 2 hours, aged in an atmosphere of 25° C. and 36% RH for 3 days, and dried at 105° C. for 1 hour. Thereafter, the wood pieces were immersed in a 10% zinc chloride aqueous solution under atmospheric pressure for 20 seconds, aged in an atmosphere of 25° C. and 36% RH for 1 day, and dried at 60° C. for 24 hours. In this way, modified wood pieces were obtained. They were examined by the same tests as in Examples 1 to 5. The wood treating dosage and the test results are shown in Table 2.

### Example 11

### Borate Zinc Acetate Silicone Emulsion

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. The wood pieces were then immersed in a 10% zinc acetate aqueous solution under atmospheric pressure for 20 seconds, aged in an atmosphere of 25° C. and 36% RH for 30 minutes, and dried at 105° C. for 24 hours. Thereafter, the wood pieces were immersed in silicone emulsion composition EM-1 (active components 10%) shown in Table 1 under atmospheric pressure for 20 seconds, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 2.

### Example 12

### Borate Silicone Emulsion+Zinc Acetate

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. Thereafter, a treating liquid was prepared by agitating 100 parts of silicone emulsion composition EM-1 (active components 10%) shown in Table 1 and 6 parts of a 10% zinc acetate aqueous solution at room temperature and atmospheric pressure, and the wood pieces were immersed in this treating liquid under atmospheric pressure for 30 seconds, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 2.

### Example 13

### Borate Zinc Chloride Silicone Emulsion

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. The wood pieces were then immersed in a 10% zinc chloride aqueous solution under atmospheric pressure for 20 seconds, aged in an atmosphere of 25° C. and 36% RH for 30 minutes, and dried at 60° C. for 1 hour. Thereafter, the wood pieces were immersed in silicone emulsion composition EM-1 (active components 10%) shown in Table 1 under atmospheric pressure for 20 seconds, aged in an atmosphere of 25° C. and 36% RH for 1 day, and dried at 60° C. for 24 hours. In this way, modified wood pieces were obtained. They were examined by the same tests as in Examples 1 to 5. The wood treating dosage and the test results are shown in Table 2.

### Example 14

### Borate Silicone Emulsion+Zinc Chloride

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. Thereafter, a treating liquid was prepared by agitating 100 parts of silicone emulsion composition EM-1 (active components 10%) shown in Table 1 and 6 parts of a 10% zinc chloride aqueous solution at room temperature and atmospheric pressure, and the wood pieces were immersed in this treating liquid under atmospheric pressure for 30 seconds, aged in an atmosphere of 25° C. and 36% RH for 1 day, and dried at 60° C. for 24 hours. In this way, modified wood pieces were obtained. They were examined by the same tests as in Examples 1 to 5. The wood treating dosage and the test results are shown in Table 2.

### Example 15

### Silicone Emulsion+Borate Calcium Acetate

A borate Timbor® was dissolved in deionized water to form a 6% aqueous solution. The silicone emulsion composition EM-1 shown in Table 1 was diluted with deionized water to a concentration of 11.2% of active components. A treating liquid was prepared by mixing 100 parts of the 6% borate aqueous solution with 100 parts of the silicone emulsion composition (11.2% active components). Wood pieces were immersed in the liquid under a reduced pressure of −93 kPa for 2 hours, aged in an atmosphere of 25° C. and 36% RH for 3 days, and dried at 105° C. for 1 hour. Thereafter, the wood pieces were immersed in a 10% calcium acetate aqueous solution under a reduced pressure of −93 kPa for 10 minutes, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 3.

### Example 16

### Borate Calcium Acetate Silicone Emulsion

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. The wood pieces were then immersed in a 10% calcium acetate aqueous solution under atmospheric pressure for 20 seconds, aged in an atmosphere of 25° C. and 36% RH for 30 minutes, and dried at 105° C. for 1 hour. Thereafter, the wood pieces were immersed in silicone emulsion composition EM-1 (active components 10%) shown in Table 1 under atmospheric pressure for 20 seconds, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 3.

### Example 17

### Borate Silicone Emulsion+Calcium Acetate

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. Thereafter, a treating liquid was prepared by agitating 100 parts of silicone emulsion composition EM-1 (active components 10%) shown in Table 1 and 6 parts of a 10% calcium acetate aqueous solution at room temperature and atmospheric pressure, and the wood pieces were immersed in this treating liquid under atmospheric pressure for 30 seconds, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 3.

### Example 18

### Silicone Emulsion+Borate Calcium Chloride

A borate Timbor® was dissolved in deionized water to form a 6% aqueous solution. The silicone emulsion composition EM-1 shown in Table 1 was diluted with deionized water to a concentration of 11.2% of active components. A treating liquid was prepared by mixing 100 parts of the 6% borate aqueous solution with 100 parts of the silicone emulsion composition (11.2% active components). Wood pieces were immersed in the liquid under a reduced pressure of −93 kPa for 2 hours, aged in an atmosphere of 25° C. and 36% RH for 3 days, and dried at 105° C. for 1 hour. Thereafter, the wood pieces were immersed in a 10% calcium chloride aqueous solution under a reduced pressure of −93 kPa for 10 minutes, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 3.

### Example 19

### Borate Calcium Chloride Silicone Emulsion

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. The wood pieces were then immersed in a 10% calcium chloride aqueous solution under atmospheric pressure for 20 seconds, aged in an atmosphere of 25° C. and 36% RH for 30 minutes, and dried at 105° C. for 1 hour. Thereafter, the wood pieces were immersed in silicone emulsion composition EM-1 (active components 10%) shown in Table 1 under atmospheric pressure for 20 seconds, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 3.

### Example 20

### Borate Silicone Emulsion+Calcium Chloride

Wood pieces were immersed in a 3% solution of a borate Timbor® in deionized water under a reduced pressure of −93 kPa for 2 hours, aged in an atmosphere of 25° C. and 36% RH for 3 days, and dried at 105° C. for 1 hour. Thereafter, a treating liquid was prepared by agitating 100 parts of silicone emulsion composition EM-1 (active components 10%) shown in Table 1 and 6 parts of a 10% calcium chloride aqueous solution at room temperature and atmospheric pressure, and the wood pieces were immersed in this treating liquid under atmospheric pressure for 30 seconds, aged in an atmosphere of 25° C. and 36% RH for 1 day, and dried at 105° C. for 24 hours. In this way, modified wood pieces were obtained. They were examined by the same tests as in Examples 1 to 5. The wood treating dosage and the test results are shown in Table 3.

### Example 21

### Borate Zinc Acetate Silicone Emulsion

### All Room Temperature Drying

Wood pieces were immersed in a 3% solution of a borate Timbor® in deionized water under a reduced pressure of −93 kPa for 2 hours, aged and dried in an atmosphere of 25° C. and 36% RH for 3 days. The wood pieces were then immersed in a 10% zinc acetate aqueous solution under atmospheric pressure for 20 seconds and dried in an atmosphere of 25° C. and 36% RH for 1 day. Thereafter, the wood pieces were immersed in silicone emulsion composition EM-1 (active components 10%) shown in Table 1 under atmospheric pressure for 20 seconds and dried in an atmosphere of 25° C. and 36% RH for 3 days. In this way, modified wood pieces were obtained. They were examined by the same tests as in Examples 1 to 5. The wood treating dosage and the test results are shown in Table 3.

### Comparative Example 1

Untreated wood pieces were examined by the same tests as in Examples 1 to 5. The test results are shown in Table 4.

### Comparative Example 2

Test samples were prepared as in Examples 1 to 5 except that the 10% zinc acetate aqueous solution was omitted. The wood treating dosage and the test results are shown in Table 4. Notably the silicone emulsion composition used was EM-1.

### Comparative Example 3

Test samples were prepared as in Examples 1 to 5 except that the silicone emulsion composition was omitted. The wood treating dosage and the test results are shown in Table 4.

### Comparative Example 4

Test samples were prepared as in Examples 1 to 5 except that the sole treatment was immersion in a 10% dispersion of a borate Timbor® in deionized water. The wood treating dosage and the test results are shown in Table 4.

### Comparative Example 5

Test samples were prepared as in Examples 1 to 5 except that the silicone emulsion composition EM-6 shown in Table 1 was used. The wood treating dosage and the test results are shown in Table 4.

Components (F) and (G) in Tables 2 to 4 are identified below.

Component F:
borate N₂B₈O₁₃.4H₂O

Component G:
G-1: zinc acetate
G-2: zinc chloride
G-3: calcium acetate
G-4: calcium chloride

TABLE 2

| Treating | | | | | | | | | | | | | | |
|---|---|---|---|---|---|---|---|---|---|---|---|---|---|---|
| dosage | | | | | | | | | | | | | | |
| (in solid weight | Example | | | | | | | | | | | | | |
| ratio) | 1 | 2 | 3 | 4 | 5 | 6 | 7 | 8 | 9 | 10 | 11 | 12 | 13 | 14 |
| EM-1 | 100 | | | | | 100 | 100 | 100 | 100 | 100 | 100 | 100 | 100 | 100 |
| EM-2 | | 100 | | | | | | | | | | | | |
| EM-3 | | | 100 | | | | | | | | | | | |
| EM-4 | | | | 100 | | | | | | | | | | |
| EM-5 | | | | | 100 | | | | | | | | | |
| F | 52 | 54 | 59 | 55 | 52 | 11 | 248 | 50 | 52 | 50 | 88 | 97 | 92 | 93 |
| G-1 | 58 | 56 | 54 | 62 | 56 | 64 | 59 | 11 | 88 | | 97 | 10 | | |
| G-2 | | | | | | | | | | 64 | | | 94 | 13 |
| Water absorption | 19 | 20 | 22 | 20 | 25 | 24 | 25 | 16 | 32 | 19 | 23 | 22 | 21 | 20 |
| after 24 hr (%) | | | | | | | | | | | | | | |
| BAE (kg/m³) | 6.5 | 7.2 | 6.8 | 6.4 | 6.1 | 5.3 | 7.0 | 5.6 | 5.7 | 6.3 | 6.5 | 6.8 | 6.4 | 6.9 |

TABLE 3

| Treating dosage | Example | | | | | | |
|---|---|---|---|---|---|---|---|
| (in solid weight ratio) | 15 | 16 | 17 | 18 | 19 | 20 | 21 |
| EM-1 | 100 | 100 | 100 | 100 | 100 | 100 | 100 |
| EM-2 | | | | | | | |
| EM-3 | | | | | | | |
| EM-4 | | | | | | | |
| EM-5 | | | | | | | |
| F | 54 | 88 | 89 | 55 | 92 | 97 | 89 |
| G-1 | | | | | | | 95 |
| G-3 | 56 | 91 | 12 | | | | |
| G-4 | | | | 62 | 93 | 11 | |
| Water absorption | 19 | 20 | 22 | 20 | 25 | 24 | 25 |
| after 24 hr (%) | | | | | | | |
| BAE (kg/m³) | 7.0 | 6.3 | 6.8 | 6.4 | 6.9 | 6.8 | 7.0 |

TABLE 4

| Treating dosage | Comparative Example | | | | |
|---|---|---|---|---|---|
| (in solid weight ratio) | 1 | 2 | 3 | 4 | 5 |
| EM-1 | | 100 | | | |
| EM-2 | | | | | |
| EM-3 | | | | | |
| EM-4 | | | | | |
| EM-5 | | | | | |
| EM-6 | | | | | 100 |
| F | | 51 | 100 | 100 | 53 |
| G-1 | | | 98 | | 56 |
| Water absorption after 24 hr (%) | 111 | 21 | 87 | 120 | 62 |
| BAE (kg/m³) | — | 2.2 | 1.8 | 0.01 | 0.4 |

Japanese Patent Application No. 2009-296743 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1-6. (canceled)

7. A method for treating wood, comprising
providing a silicone emulsion composition [I] by dispersing and emulsifying in water (A) 100 parts by weight of an organopolysiloxane containing at least two silicon-bonded hydroxyl groups on the molecule, (B) 0.5 to 20 parts by weight of the reaction product of an amino-containing organoxysilane and an acid anhydride, (C) 0 to 20 parts by weight of an epoxy-containing organoxysilane and/or partial hydrolyzate thereof, (D) 0 to 50 parts by weight of colloidal silica and/or polysilsesquioxane, and (E) 0 to 10 parts by weight of a curing catalyst,
providing (F) 10 to 1,500 parts by weight of a boron compound and (G) 10 to 300 parts by weight of a di- or trivalent metal salt per 100 parts by weight of active components exclusive of water in the silicone emulsion composition [I], all calculated as solids,
treating a wood with a dispersion containing the silicone emulsion composition [I] and the boron compound (F) by coating, immersion, or vacuum or pressure impregnation, and
then treating the wood with the di- or trivalent metal salt (G) by coating or immersion,
thereby obtaining the treated wood having the amount of residual borate in wood in terms of boric acid of at least 5 kg/m³ after the leach-out test of JIS K 1571.

8. (canceled)

9. A method for treating wood, comprising
providing a silicone emulsion composition [I] by dispersing and emulsifying in water (A) 100 parts by weight of an organopolysiloxane containing at least two silicon-bonded hydroxyl groups on the molecule, (B) 0.5 to 20 parts by weight of the reaction product of an amino-containing organoxysilane and an acid anhydride, (C) 0 to 20 parts by weight of an epoxy-containing organoxysilane and/or partial hydrolyzate thereof, (D) 0 to 50 parts by weight of colloidal silica and/or polysilsesquioxane, and (E) 0 to 10 parts by weight of a curing catalyst,
providing (F) 10 to 1,500 parts by weight of a boron compound and (G) 10 to 300 parts by weight of a di- or trivalent metal salt per 100 parts by weight of active components exclusive of water in the silicone emulsion composition [I], all calculated as solids,
treating a wood with the boron compound (F) by coating, immersion, or vacuum or pressure impregnation,
treating the wood with the di- or trivalent metal salt (G) by coating or immersion, and
then treating the wood with the silicone emulsion composition [I] by coating or immersion,
thereby obtaining the treated wood having the amount of residual borate in wood in terms of boric acid of at least 5 kg/m³ after the leach-out test of JIS K 1571.

10. The method of claim 7 wherein the di- or trivalent metal salt (G) is zinc acetate, zinc chloride, calcium acetate or calcium chloride.

11. The method of claim 7 wherein the boron compound (F) is disodium octaborate tetrahydrate.

12-13. (canceled)

14. The method of claim 7 wherein the curing catalyst of component (E) is selected from the group consisting of dibutyltin dilaurate, dibutyltin dioctate, dioctyltin dilaurate, dioctyltin diversatate, dioctyltin diacetate, dibutyltin bisoleylmaleate, tin octylate, and iron octylate, and amine compounds, and is incorporated in an amount of 0.5 to 10 parts by weight per 100 parts by component (A), and the di- or trivalent metal salt of component (G) is selected from the group consisting of alkaline earth metal salts, zinc salts and aluminum chloride.

15. The method of claim 9 wherein the curing catalyst of component (E) is selected from the group consisting of dibutyltin dilaurate, dibutyltin dioctate, dioctyltin dilaurate, dioctyltin diversatate, dioctyltin diacetate, dibutyltin bisoleylmaleate, tin octylate, and iron octylate and amine compounds, and is incorporated in an amount of 0.5 to 10 parts by weight per 100 parts by component (A), and the di- or trivalent metal salt of component (G) is selected from the group consisting of alkaline earth metal salts, zinc salts and aluminum chloride.
